(19) United States
(12) Patent Application Publication
(10) Pub. No.: US 2015/0040027 A1
(43) Pub. Date: Feb. 5, 2015

(54) Portable Device with Handedness Switching Module

(71) Applicants: Yi-Chuan CHENG, Yongjing Township (TW); Mei Ling LO, New Taipei City (TW); Kuo-Ching CHIANG, New Taipei City (TW)

(72) Inventors: Yi-Chuan CHENG, Yongjing Township (TW); Mei Ling LO, New Taipei City (TW); Kuo-Ching CHIANG, New Taipei City (TW)

(21) Appl. No.: 14/447,643

(22) Filed: Jul. 31, 2014

(30) Foreign Application Priority Data
Jul. 31, 2013 (TW) 102127539
Jan. 10, 2014 (TW) 103100950

(51) Int. Cl. G06F 3/0484; G06F 3/0482

(52) U.S. Cl. CPC G06F 3/04842; G06F 3/0482
USPC 715/747

(57) ABSTRACT

A method of generating a user interface for a portable communication device includes providing a control unit, a display coupled to the control unit, and a handedness switching module coupled with the control unit to generate one of a right hand handedness user interface and a left hand handedness user interface, followed by generating the right hand handedness user interface or the left hand handedness user interface selected by a user; The next is to display the selected right hand handedness user interface or the left hand handedness user interface on the display, wherein the arc shaped dialing interface includes pluralities of number arranged along an arc shaped dialing zone on the arc shaped dialing interface, wherein the arc shaped dialing interface includes pluralities of number arranged along an arc shaped dialing zone on the arc shaped dialing interface.

### CROSS-REFERENCE TO RELATED APPLICATIONS

The application claims benefit of TAIWAN Patent Application Serial Number 102127539 and 103100950, filed on Jul. 31, 2013 and Jan. 10, 2014 respectively, which are herein incorporated by reference.

### TECHNICAL FIELD

The present invention relates to a portable communication device, particularly to a portable device having handedness interface switching module

### BACKGROUND OF RELATED ART

Because of the development of the information technology (IT), the information could be exchanged with higher capacity and faster speed. Internet is designed as an open structure to exchange information freely without restriction. The third or fourth generation mobile phone standard allows the user to access video communication through the air. Thus, certain communication service requiring real time information exchange, such as viewing a live video, has become feasible through mobile phone communication network or Internet. Portable computers and personal computer or smart phone have been widely used for each area. However, the user interface design for the mobile phone is almost identical and is typically set for right-hand handedness user. It is inconvenience to the left-hand handedness user.

### SUMMARY

The present invention provides a system for communication via internet comprising a local area network and a terminal is coupled to the internet; a portable device with dual network linking capability module is used to transmit information through a RF module via the cellular network or the wireless local area network (WLAN) module via the Internet, wherein the portable device includes an internet phone module and the WLAN module to allow an user may synchronously transmit or receive data through the internet, portably, wherein the transmitted information is selected from audio signal, video signal and the combination thereof. The terminal can be a computer, a personal digital assistant (PDA), a notebook, cellular or a smart phone, which is able to access the internet network via the local area network. The system further comprises a mobile phone communication service network. The system further comprises an exchanging service mechanism bridging the internet and the mobile phone network to facilitate the communication there between.

The present invention discloses a method of generating a handedness interface for a portable communication device, the method includes steps of providing a control unit, a display coupled to the control unit; and a handedness switching module coupled with the control unit to generate one of a right hand handedness user interface and a left hand handedness user interface. The users may trigger the handedness switching module to switch the right hand handedness user interface or the left hand handedness user interface, followed by generating the handedness interface selected by a user. The next step is to display the selected right hand handedness user interface or the left hand handedness user interface on the display.

The switchable handedness user interface module includes a phone number address book having photo stick, user name and phone number. The arrangement of the right hand user interface is opposite to the one of the left hand user interface. The method further includes a ranking module being responsive to a usage frequency of a list of contact person to re-arrange the list of contact person to allow high ranking contact person is listed on a top or a first page of an interface displayed on the display. An internet communication module is coupled to the control unit to transmit or receive data through a local area network module.

In a preferred embodiment, the handedness interface module includes an arc shaped dialing interface. The arc shaped dialing interface includes pluralities of number (typically, 0-9) arranged along an arc shaped dialing zone on the arc shaped dialing interface. The arc shaped dialing interface includes pluralities of alphabet arranged along an arc shaped dialing zone on the arc shaped dialing interface. The arc shaped dialing zone may include one or more arc band for arranging the numbers in the bands.

A portable communication, comprises a control unit, a display coupled to the control unit; a contact book coupled to the control unit to store a list of contact person's phone number, e-mail address, account information, or the combination; a ranking module being responsive to a usage frequency of the list of contact person to re-arrange the list of contact person to allow high ranking contact person is listed on a top or a first page of an interface displayed on the display; a phone filter including an interface on a display to allow a user to input a black list of person and corresponding phone number to filter out a phone which is listed in the black list. A signal of the incoming phone is received, the phone filter checks whether or not the incoming phone number is listed on the black list; if the incoming phone is already listed in the black list, the phone filter hands off the phone automatically. A multi-tasking module is coupled to the control unit for reassigning the control unit between at least one task and another task to achieve parallelism. A network communication phone module is coupled to the control unit to transmit or receive data through a local area network module. A user motion control module is coupled to the control unit. The display includes multiple display windows including at least one main window and at least one sub-window. A selected program is assigned into the main window.

### BRIEF DESCRIPTION OF THE DRAWING:

For a better understanding of the present invention and to show how it may be implemented, reference will now be made to the following drawings:

FIG. 1 is a block diagram showing the device of the present invention.

FIG. 2 shows the device having a policy engine of the present invention.

FIG. 3A shows the ranking interface of the present invention.

FIG. 3B shows the ranking interface of the present invention.

FIG. 4A shows a right hand handedness user interface according to the present invention.

FIG. 4B shows a left hand handedness user interface according to the present invention.

FIG. 5A shows a right hand handedness user interface according to the present invention.

FIG. 5B shows a left hand user handedness interface according to the present invention.

FIG. 5C shows a right hand user handedness interface according to the present invention.

FIG. 5D shows a left hand handedness user interface according to the present invention.

### DETAILED DESCRIPTION

The present invention is described with the preferred embodiments and accompanying drawings. It should be appreciated that all the embodiments are merely used for illustration. Hence, the present invention can also be applied to various embodiments other than the preferred embodiments.

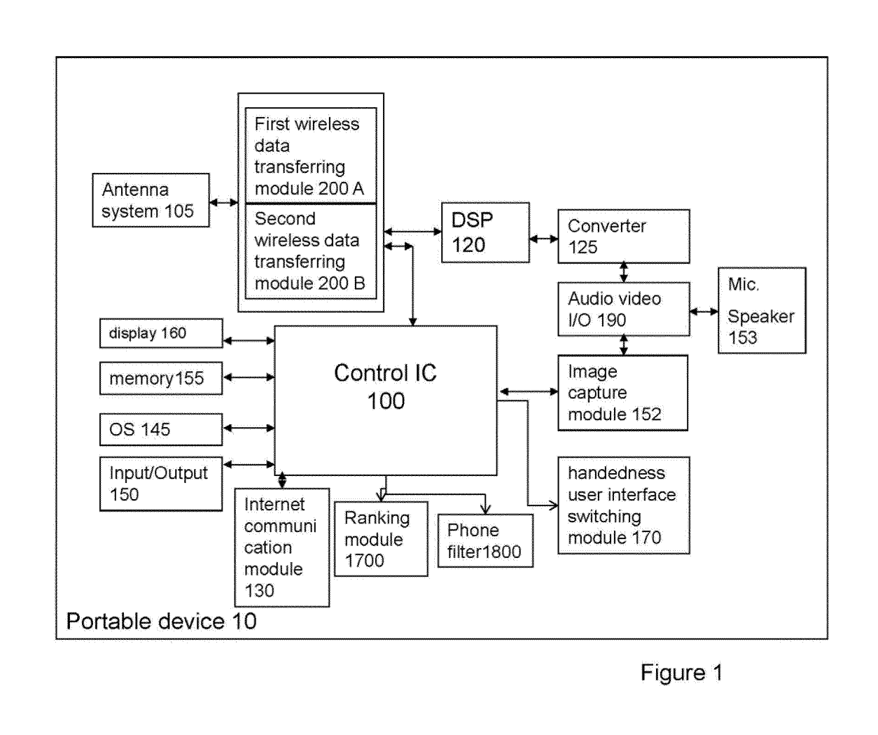

Referring to Figure. 1, it illustrates the functional diagram of the portable device 10 with dual networks capability. The dual way portable terminal 10 with SIM card connector to carry the SIM card, it is well known in the art, the SIM card is not necessary for some other type of cellular such as PHS or some CDMA system. The diagram is used for illustrating and not used for limiting the scope of the present invention. Please refer to FIG. 1. The portable terminal or device 10 includes a first and a second wireless data transferring modules 200A, 200B. The first wireless data transferring module 200A could be video RF module to transmit or receive mobile phone signal and it is well known in the art. As know in the art, the RF unit is coupled to an antenna system 105. The RF module may include base band processor and so on. This antenna is connected to a transceiver, which is used to receive and transmit signal. The first wireless data transferring modules 200A is compatible to the mobile phone protocol such as W-CDMA, CDMA2000, CDMA2001, TD-CDMA, TD-SCDMA, UWC-136, DECT, 4G system. There systems allow the user communicates with video communication. The RF module may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 153 including loudspeaker and a microphone. The module 200A, 200B can be formed by separated module (chip) or integrated chip.

The device 10 may include DSP 120, CODEC (not shown) and A/D converter 125 as well. The present invention includes a central control unit 100, a wired input/output 150, a build-in display 160, OS (operation system) 145 and memory 155 including a ROM program memory, a RAM memory and a nonvolatile FLASH memory. All of the units mentioned above are coupled to the central control unit 100, respectively. The memory could be micro-type hard disc. The wired I/O interface 150 is coupled to the central control unit 100. The wired I/O interface could be USB, IEEE1394. An audio/video I/O 190 is coupled to between the A/D converter 125 and the Mic. and speaker 153.

The device 10 further includes the second wireless data transferring modules 200B. In one embodiment, a wireless local area network (WLAN) module is employed and it could be compatible to the local area network protocol or standard such as Bluetooth standard, Wi-Fi standard, or 802.11x (x refers to a, b, g, n) standard compatible module. Further, the wireless local area network (WLAN) module could be compatible to the WiMAX (Worldwide Interoperability for Microwave Access) standard or specification. An Internet phone module 130 are coupled to the central control unit 100 to allow transmit and receive the audio, video or both type signal to/from the internet network through the wireless local area wireless transmission module. Internet communication module 130 at least meets the standard of terminal-terminal Voice Over Internet Protocol (VoIP). One of the examples is Skype compatible protocol. By using of the Internet communication module 130 and the wireless local area network module 200B, the user may portably, synchronously transmit and receive the vocal, image or both signal through the internet by using the internet communication module 130. The present invention defines a hand-held device having internet communication module and wireless WiFi or WiMax network linking module coupled to the communication module 130 to allow the user to make a wireless terminal-terminal communication through WiFi to reduce the fee.

The devices are coupled to Internet network, the data exchange between the terminals could be implemented directly through the Internet. Apparently, the computing devices includes the terminal-to-terminal VoIP system, such as Skype Phone system or the on-line instant chat system, application or module and from the FIG. 1, the terminals maybe coupled directly by network without the client-server system for the VoIP. Unlike server-client system, the present invention is a terminal-to-terminal system or semi-terminal-to-terminal system rather than a client-server system, and makes use of background processing on computing devices running software. Thus, it may allow the computing device to communicate with other terminals without server-client structure. An image capturing module 152 is required and coupled to the central control unit 100 to catch the video image if the user would like to conduct the real-time video transmission. The image capturing module 152 could be digital still camera, digital video camera. Therefore, the real-time portable conference is possible. In another embodiment, the one difference is that the device may omit the RF module. If the device 10 includes 3G or higher level RF module, the user may transmit the video phone through the air. Therefore, the user may select one of the schemes to make a video call through internet or air depending on the user demand. If the device is within the hot spot area, the user may choose the usage of the internet communication module for communication due to cheaper transmitting fee. If the out of the hot spot range, the other option for video communication is provided. Typically, the WCDMA signal is less restricted by the geography limitation, but the transmission fee is higher. The present invention allows the user to select the proper wireless module for video communication. If the user would like to conduct the video communication through WiFi or WiMax, the method includes coupling to internet or hot spot, followed by activating the internet communication module. Subsequently, vocal signal is input from the speaker and image data is captured from the image capture device, subsequently, the image data and the vocal signal are converted from signal to digital. After the conversion, the image data and the vocal signal are composition, compressed or processed to form a data streams. Therefore, the data may be transmitted to the receiving party seriously. BER of less than about 10.sup.-5 at the channel decoder output is considered desirable for digital music and video transmissions. The bits in a given source coded bit stream (e.g., a compressed audio, image or video bit stream) often have different levels of importance in terms of their impact on reconstructed signal quality. As a result, it is generally desirable to provide different levels of channel error protection for different portions of the source coded bit stream. Techniques for use in providing such unequal error protection (UEP) through the use of different channel codes are described in U.S. patent application Ser. No. 09/022,114, filed Feb. 11, 1998, and entitled “Unequal Error Protection for Perceptual Audio Coders,”. A source coded bit stream is divided into different classes of bits, with different levels of error protection being provided for the different classes of bits.

The device may couple to the internet via the wired data I/O interface or the WLAN module 200B to upload or download data including digital data such as text format, image format, audio signal, video signal. The wired data I/O interface 150 is coupled to the central control unit 100. The application of the apparatus is quite economical and convenience. Moreover, the user may call other one by the internet phone module to reduce the transmission fee when the local area wireless transmission module detects the signal of the internet network. Otherwise, the user may use the WCDMA for video communication. The portable real-time video conference is possible by implementation of the present invention. Further, the present invention provides dual modes (3G or internet video phone) portable audio/video communication, synchronously.

The present invention further includes a wireless transmission/receiving module 220A coupled to the control IC 100A. The transmission/receiving module is compatible with blue-tooth, home-RF, 802.11x, WiFi, WiMAX standard or their higher version. The transmission domain (the air) by nature is not secured and therefore encryption maybe essential in the wireless transport networks. In one embodiment, pair-wise encryption/decryption between every neighboring wireless network device of a wireless transport network is well-known in the art. A data frame that leaves from one wireless device from one end of a wireless transport network to the other end of the same network might need several encryptions and decryptions before it reaches its final destination.

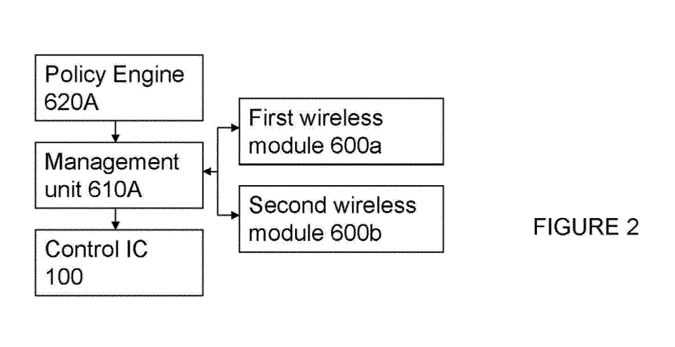

In another embodiment, the wireless data transferring module 220A includes dual mode module. Please refer to FIG. 2, in one case, the wireless data transferring module 220A includes a first and second wireless module 600a and 600b for wireless transmission. The dual modules 600a and 600b are coupled to a management unit 600A to manage the dual modules according to the policy set in a policy engine 610A. For example, the policy in the policy engine 610A includes at least the transmission priority policy to determine which module will be the default module to receive/transmit data. It also includes the switching condition for switching there between. For example, the signal strength is one of the facts for switch condition. It also allows the user to set or alter the condition via user interface. The first and second wireless module maybe one of the following module: blue-tooth, 802.11x, WiFi, WiMAX, 3G, 4G standard or their higher (update) version. Preferably, the first wireless module is WiFi and the second wireless module is WiMax. The present invention may yield the benefits of both. For example, the access range of WiFi is shorter than WiMax, but it consumes lower power. If within the office area, the AP for WiFi may be employed to prevent others outside the office from accessing the server of the office. In another aspect, if the user would like to access or remote control a terminal device located at several miles away, the WiMax is chosen. The WiFi benefits security, low power consumption while WiMax yields long range and high bandwidth. The module architecture refers to dual wireless module (DWM). The DWM has the benefits of the both type of module. The first wireless module is compatible to a first communication protocol, while the second one is compatible to a second communication protocol. The manufacture may increase the performance by incorporating the two kind of wireless module memory with an optimized configuration. The protocol maybe adapted to wireless local area network or wireless mediate area network.

The hand held electronic device may be designed to recognize gestures applied to the sensing array and to control aspects of the hand held electronic device based on the gestures. The gestures may be made through various particularly finger motions. The hand held electronic device may include a gesture operational program, which may be part of the operating system or a separate application. In one embodiment, the sensing input device is mapped to the display. When mapped, points on the sensing input device coincide with points on the display, i.e., have the same coordinates (x and y). Therefore, when a user touches the sensing input device surface, it will appear as if the user is touching the image at the same location of the display. As shown, the sensing array is divided into several independent and spatially distinct sensing points (or regions) that are positioned within the respective component. The sensing points are generally dispersed about the respective component with each sensing point representing a different position on the surface of the component and thus the device 10. The sensing points may be positioned in a grid or a pixel array where each pixilated sensing point is capable of generating a signal. The number and configuration of the sensing points may be widely varied. The number and configuration of sensing points generally depends on the desired resolution of the touch sensitive surface and may be varied from spot to spot across the display to achieve any desired compromise between cost and functionality. In the case, a signal is produced each time the finger is positioned over a sensing point. When an object is placed over multiple sensing points or when the object is moved between or over multiple sensing points, multiple position signals are generated. As should be appreciated, the number, combination and frequency of signals in a given time frame may indicate size, location, direction, speed, acceleration and the pressure of the finger or palm on the surface of the device. By way of example, the control system may be a microcontroller located within the housing of the device .

The signals generated at the sensing points may be used to determine how the user would like to move the web page displayed on the display. For example, each portion of the hand in contact with the device produces a contact patch area. Each of the contact patch areas covers several sensing points thus generating several signals. The signals may be grouped together to form a signal that represents how the user is moving the web page. In one embodiment, the difference between a current signal and a last hand signal may indicate the user's desire to implement a function of moving web-page. A significant difference indicates the user's desire to implement a function. Changes between contact patch areas may further indicate the particular moving signal. In mapping, the touch surface is divided into one or more button zones that represent regions of the device that when selected implement the particular button function associated with the button zone. The button zone having the contact patch area with the most significant change between first and second hand signals is the one that is typically implemented. The position and size of the button zones may also be customizable. For example, page back, page next and so on. The customization may be performed by the user and/or the device.

The processor can be implemented on a single-chip, multiple chips or multiple electrical components. For example, various architectures can be used for the processor, including dedicated or embedded processor, single purpose processor, controller, ASIC, and so forth. In most cases, the processor together with an operating system operates to execute computer code and produce and use data. The operating system may correspond to well-known operating systems such as OS/2, DOS, Unix, Linux, and Palm OS. Memory provides a place to store computer code, the memory may include Read-Only Memory (ROM), Random-Access Memory (RAM), hard disk drive, flash memory and/or the like. The display is generally configured to display a graphical user interface (GUI) that provides an easy to use interface between a user of the electronic device and the operating system or application running thereon. The electronic device also includes a touch screen that is operatively coupled to the processor. The touch screen is configured to transfer data from the outside into the device. The electronic device also includes a sensing device that is operatively coupled to the processor. The sensing device may also be used to issue web page moving commands.

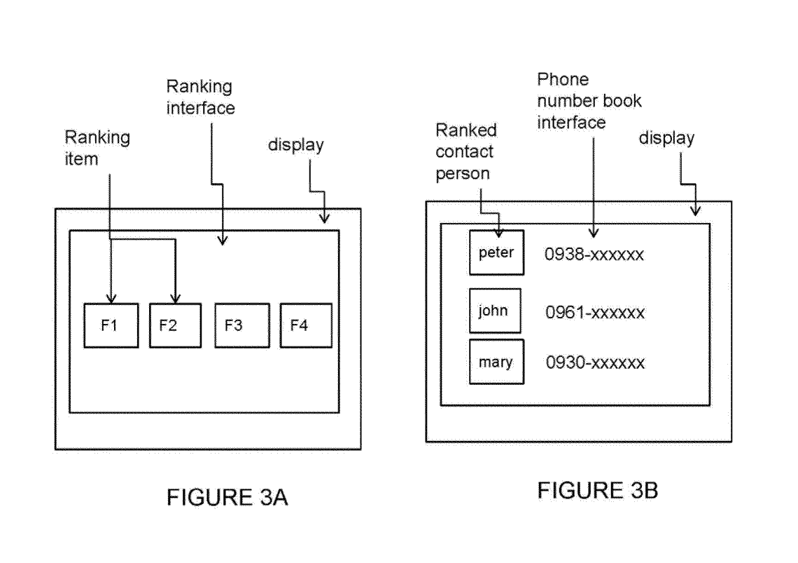

Another alternative embodiment includes is illustrated in FIG. 1, the present embodiment further includes the ranking module 1700 which is coupled to the control unit to analysis the most favorite contact person, website, or skype user. The module may be incorporated into the cellular device and smart phone or tablet computer a shown in the FIG. 1. In the case, the ranking module 1700 is coupled with the control unit 100 in FIG. 1. The ranking is based on the number of time (or frequency) of communication between the user and the contact person within a period of time or the number of time (or frequency) that the user links to the website within a period of time. Therefore, the ranking module 1700 will have the communication or website linking frequency data calculated by the ranking module 1700 or additional counter of the devices. It will rank my favorite dynamically and display the high ranking contact person, website, or skype user on the interface of desk top or the interface of the address book (or phone number book), account book, my favorite interface dynamically as show in FIG. 3A and 3B. The ranking module 1700 will re-arrange arrange the queue of the contact person and its related information, such as phone number, e-mail address, user account dynamically based on the frequency of use. If the ranking is altered, the ranking module 1700 will change and re-arrange the queue of the contact person, website, or skype user. In the prior art, the phone number is listed based on the alphabet. The people's name with alphabet A is always listed at the top of the list, however, the people is not necessarily high ranking. The module 1700 can be used in the cellular to dynamically re-arrange the list of the address book, contact book or the phone number book based on the frequency of usage to allow the most high ranking person or website will be listed on the top of the list or first page of the user interface. The device also includes phone filter 1800 coupled to the control unit as shown in FIG. 1. The phone filter 1800 includes an interface on the display to allow the user to input the black list of person and corresponding phone number. When the signal of the incoming phone is received, the phone filter 1800 will check whether or not the phone number is listed on the black list. If the incoming phone is already listed in the black list, the phone filter 1800 will hand off the phone automatically without the user action.

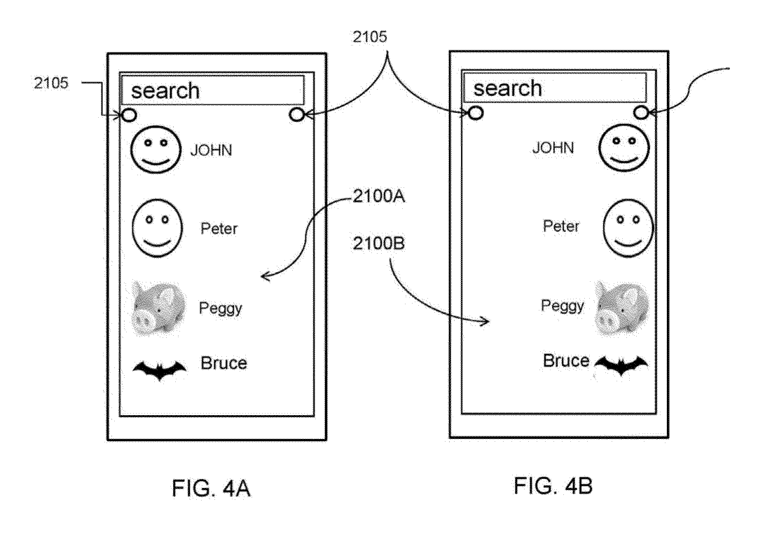

The present invention provides a handedness user interface switching module 170 which may generate a right hand handedness user interface or left land handedness user interface on the display to allow the user switch the interface depending on the handedness of the user, as shown in FIG. 4A, 4B. The arrangements of right hand handedness user interface 2100A and left hand handedness user interface 2100B are opposite. As known in the art, the phone number address book includes the photo stick, user name and the phone number. The configuration in the right hand handedness user interface is opposite to the one of the left hand handedness user interface. For example, the photo sticker of the right hand handedness user interface is set at the left hand side, while the photo sticker of the left hand handedness user interface is set at the right hand side. At least one handedness interface switching icon 2105 is arranged on the right hand handedness user interface and left hand handedness user interface to allow the user press the icon 2150 for switching the handedness interface.

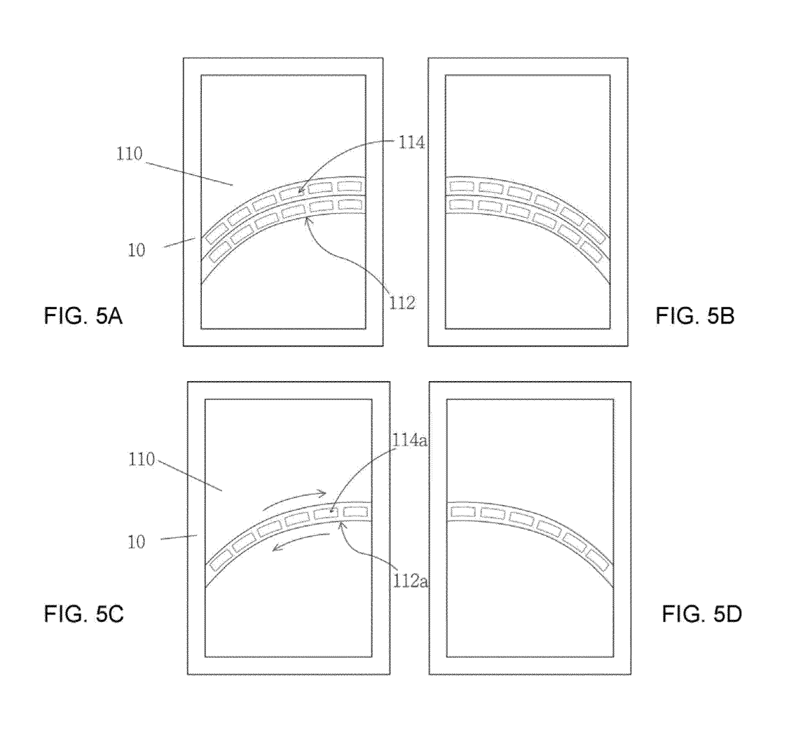

In a preferred embodiment, the present invention includes an arc shaped dialing interface 110 as shown in FIG. 5A and 5B which show the right hand handedness user interface and left hand handedness user interface respectively. The arc shaped dialing interface 110 includes an arc shaped dialing zone 112 having virtual buttons arranged thereon to allow the user dial the phone. The arc shaped dialing zone may include one or more arc band for arranging the numbers in the arc bands. The arc shaped interface is benefit to the user to dial the phone, the number and the alphabet are arranged along the arc shape zone. The thumb of the user may sweep over the entire arc shape zone. It is more convenient than the conventional rectangular matrix grid type dialing interface. FIG. 5C and 5D shows other embodiments, they indicate that the number and the alphabet symbols or virtual icons are movable back and forth by the user finger when the finger touches the arc shaped zone. The finger may move the icon or symbol to the desired location on the display to allow the finger presses it.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

We claim:

1. A method of generating a handedness interface for a portable communication device, comprising: providing a control unit, a display coupled to said control unit; and a handedness switching module coupled with said control unit to generate one of a right hand handedness user interface and a left hand handedness user interface;
generating said right hand handedness user interface or said left hand handedness user interface selected by a user; and
displaying said selected right hand handedness user interface or said left hand handedness user interface on said display.

2. The method as set forth in claim 1, wherein said handedness switching module includes a phone number address book having photo stick, user name and phone number.

3. The method as set forth in claim 2, wherein an arrangement of said right hand handedness user interface is opposite to said left hand handedness user interface.

4. The method as set forth in claim 2, further comprising a ranking module responsive to a usage frequency of a list of contact person to re-arrange said list of contact person to allow high ranking contact person is listed on a top or a first page of an interface displayed on said display.

5. The method as set forth in claim 1, further comprising an internet communication module coupled to said control unit to transmit or receive data through a local area network module.

6. The method as set forth in claim 1, wherein said handedness switching module includes an arc shaped dialing interface.

7. The method as set forth in claim 6, wherein said arc shaped dialing interface includes pluralities of number arranged along an arc shaped dialing zone on said arc shaped dialing interface.

8. The method as set forth in claim 6, wherein said arc shaped dialing interface includes pluralities of alphabet arranged along an arc shaped dialing zone on said arc shaped dialing interface.

9. A method of generating a handedness interface for a portable communication device, comprising: providing a control unit, a display coupled to said control unit; and a handedness switching module coupled with said control unit to generate one of a right hand handedness user interface and a left hand handedness user interface;
generating said right hand handedness user interface or said left hand handedness user interface selected by a user; and
displaying said selected right hand handedness user interface or said left hand handedness user interface on said display, wherein said selected right hand handedness user interface or said left hand handedness user interface includes arc shaped dialing interface having pluralities of number arranged along an arc shaped dialing zone on said arc shaped dialing interface.

10. The method as set forth in claim 9, wherein said arc shaped dialing interface includes pluralities of number arranged along an arc shaped dialing zone on said arc shaped dialing interface.

11. The method as set forth in claim 9, wherein said arc shaped dialing interface includes pluralities of alphabet arranged along an arc shaped dialing zone on said arc shaped dialing interface.

12. The method as set forth in claim 9, further includes a handedness address interface including a phone number address book having photo stick, user name and phone number.

13. The method as set forth in claim 12, wherein an arrangement of said right hand handedness user interface is opposite to said left hand handedness user interface.

14. The method as set forth in claim 12, further comprising a ranking module responsive to a usage frequency of a list of contact person to re-arrange said list of contact person to allow high ranking contact person is listed on a top or a first page of an interface displayed on said display.

15. A method of generating a handedness interface for a portable communication device, comprising: providing a control unit, a display coupled to said control unit; and a handedness switching module coupled with said control unit to generate one of a right hand handedness user interface and a left hand handedness user interface;
generating said right hand handedness user interface or said left hand handedness user interface selected by a user;
displaying said selected right hand handedness user interface or said left hand handedness user interface on said display, wherein said handedness switching module includes an arc shaped dialing interface having pluralities of number arranged along an arc shaped dialing zone on said arc shaped dialing interface.

16. The method as set forth in claim 15, wherein said arc shaped dialing interface includes pluralities of alphabet arranged along an arc shaped dialing zone on said arc shaped dialing interface.

17. The method as set forth in claim 15, further includes a handedness user address interface including a phone number address book having photo stick, user name and phone number.

18. The method as set forth in claim 17, wherein an arrangement of said right hand handedness user interface is opposite to said left hand handedness user interface.

19. The method as set forth in claim 15, further comprising a ranking module being responsive to a usage frequency of a list of contact person to re-arrange said list of contact person to allow high ranking contact person is listed on a top or a first page of an interface displayed on said display.
